(19) United States
(12) Patent Application Publication
(10) Pub. No.: US 2009/0200353 A1
(43) Pub. Date: Aug. 13, 2009

(54) Combustion-operated setting tool

(75) Inventors: Tilo Dittrich, Grabs (CH); Peter Hanimann, Salez (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/322,283

(22) Filed: Jan. 29, 2009

(30) Foreign Application Priority Data
Feb. 13, 2008 (DE) 10 2008 000 286.0

(51) Int. Cl. B25C 1/08; B25C 1/18

(52) U.S. Cl. 227/9; 227/156

(57) ABSTRACT

A combustion-operated setting tool (10) for driving-in fastening elements includes an ignition device (26) for generating an ignition spark in the combustion chamber (15), a metering device (21) for delivering fuel in the combustion chamber (15), and control electronics (25) for controlling the ignition device (26) and the metering device (21) and communicating with a plurality of sensors for sensing operational parameters of the setting tool and including at least one flue gas sensor (31) for measuring at least one flue gas component.

### BACKGROUND OF THE INVENTION

1. Field of the Invention

The present invention relates to a combustion-operated setting tool for driving-in fastening elements and including a combustion chamber for fuel, an ignition device for generating an ignition spark in the combustion chamber, a metering device for delivering fuel in the combustion chamber, and control electronics for controlling the ignition device and the metering device and connectable with a plurality of sensors for sensing operational parameters of the setting tool.

2. Description of the Prior Art

In the setting tools of the type described above, a portion of a fuel gas or of another vaporized fuel is combusted in the combustion chamber together with oxidation means such as, e.g., environmental air. Combustion energy drives a setting piston, which is displaceable in a guide cylinder, for driving a fastening element in an object.

U.S. Pat. No. 6,123,241 discloses a combustion-operated setting tool that includes control electronics for controlling ignition and fuel injection. The setting tool is provided with a plurality of sensors that measure the environmental air pressure and based on data acquired by the sensor, the control electronics controls the admission and metering of fuel that is fed from a fuel reservoir and into a combustion chamber. To this end, the control electronics cooperates with a metering valve for fuel.

The drawbacks of the control according to U.S. Pat. No. 6,123,241 consists in that, on one hand, the energy output is not optimal because unsetting influences are not or are insufficiently taken into account. On the other hand, the emission of undesirable flue gas components such as, e.g., carbon monoxide can be very high.

Accordingly, an object of the present invention is to provide a combustion-operated setting tool of the type described above in which the drawbacks of the setting tool described in U.S. Pat. No. 6,123,241 are eliminated.

Another object of the invention is to provide a combustion-operated setting tool having an optimal energy output.

### SUMMARY OF THE INVENTION

These and other objects of the present invention, which will become apparent hereinafter, are achieved by providing at least one flue gas sensor for measuring at least one flue gas component.

Based on measurement data of the flue gas after an executed setting of a fastening element, the control electronics can more precisely define the control parameters for a following setting process in order to obtain an optimal combustion and, thereby, to achieve an optimal energy output with a cleaner combustion. Thus, the metering amount of fuel and the ignition control can be set based on the measurement data acquired by the flue gas sensor. The measurement is effected after the combustion process and before fresh air is fed into the combustion chamber.

Advantageously, the flue gas sensor is designed for measuring at least one primary element such as, e.g., a fuel component, so that an incomplete combustion is detected, and the control electronics can adapt the metered amount of fuel for a following combustion process.

It is particularly advantageous when the flue gas sensor is formed as lambda probe for measuring content of residual oxygen in the flue gas. This makes direct regulation of a fuel ratio possible.

Alternatively, the flue gas sensor can be equipped for measuring a reaction product in the flue gas and be formed as carbon monoxide sensor or carbon oxide sensor. Such sensors insure a good measurement precision and are, e.g., in comparison with lambda probe, more economical.

Advantageously, the flue gas sensor is located in the combustion chamber. The advantage of such an arrangement consists in that the residence time of the sensor in the flue gas is relatively long.

Alternatively, the flue gas sensor can be located in the exhaust. The advantage of this arrangement, in particular when the flue gas sensor is formed as a lambda probe, consists in that the measurement sensor of the lambda probe can be easily brought in contact with the environmental air for determining the reference air.

Advantageously, there is provided a thermal element for the flue gas sensor. The thermal element quickly brings the flue gas sensor to its optimal operational temperature.

It is advantageous when the thermal element is controlled by the control electronics, which insures optimal regulation of the thermal element adapted to respective operation conditions.

It is further advantageous when the plurality of sensors includes a temperature sensor located in the combustion chamber. This provides for a temperature adjustment of measurement data of the flue gas sensor in the control electronics. Preferably, the temperature sensor is located in the immediate vicinity of the flue gas sensor.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a side, partially cross-sectional view of a first embodiment of a combustion-operated setting tool according to the present invention; and;

FIG. 2 a side, partially cross-sectional view of a second embodiment of a combustion-operated setting tool according to the present invention.

### DETAILED DESCRIPTION OF THE PREFERRED EMBODIMENTS

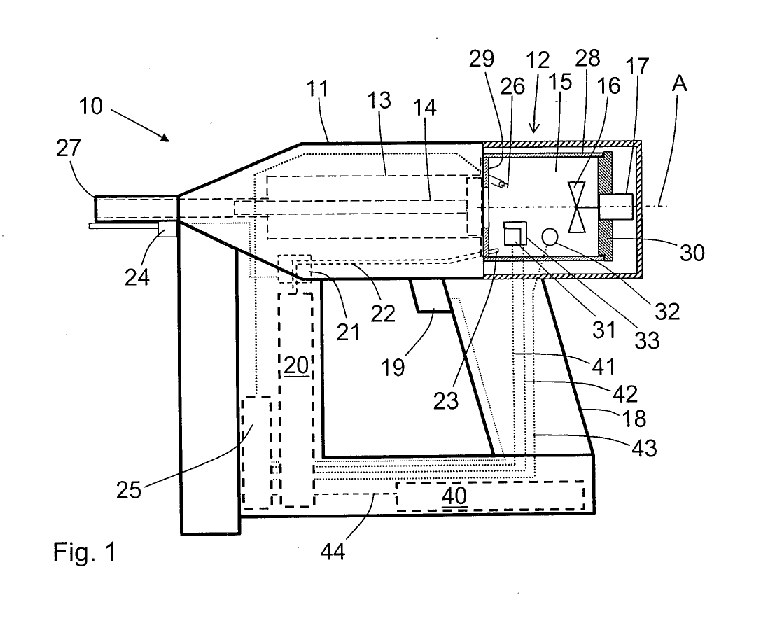

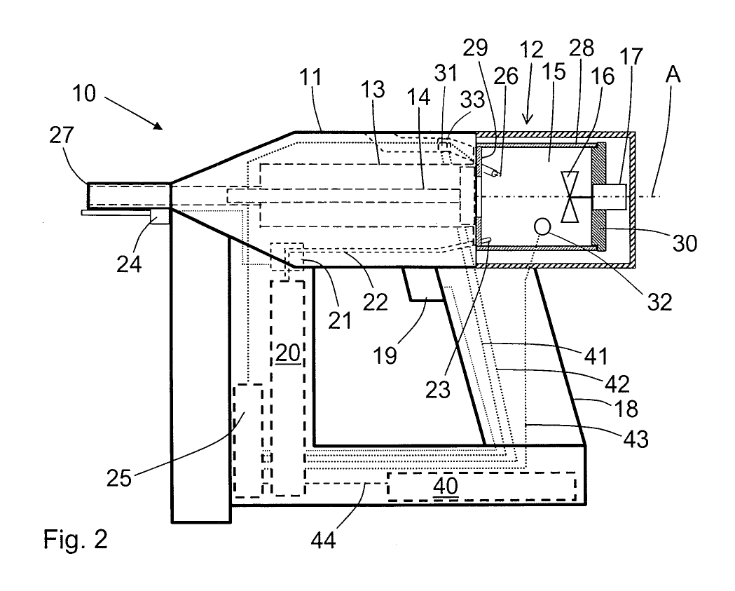

A combustion-operated setting tool 10 according to the present invention, which is shown in FIGS. 1-2, includes a one- or multi-part housing generally designated with a reference numeral 11, and a drive 12 located in the housing 11 and driven by an air-fuel mixture. With the drive 12, a fastening element, such as nail, bolt, etc. can be driven in a workpiece. The fastening elements can, e.g., be stored in a magazine secured on the setting tool 10.

The drive 12 includes, among others, a combustion chamber 15 and a guide cylinder 13 which adjoins the combustion chamber 13 and in which a setting piston 14 is axially displaceable. The combustion chamber 15, which defines a combustion chamber axis A, is limited, in its initial position shown in FIG. 1, circumferentially by a combustion chamber sleeve 28 and axially, at its first end, by the setting piston 14 and an annular combustion chamber wall 29 and, at its second end, by a combustion chamber rear wall 30 formed as a cylinder head.

A ventilator 16, which is provided in the region of the second axial end 32 and is driven by a motor 17, serves both for producing a turbulent flow regime of the air-fuel mixture located in the closed combustion chamber 15 and for flushing the open combustion chamber 15 with fresh air after completion of a setting process. The motor 17 is supported on the combustion chamber rear wall 30 that serves for closing of the axially displaceable combustion chamber sleeve 28.

As shown in FIG. 1, a trigger switch 19 is arranged on a handle 18 of the setting tool 10. The trigger switch 19 actuates, via control electronics, an ignition device 26 having an ignition element such as, e.g., a spark plug, located in the combustion chamber 15, when the setting tool 10 is pressed against a workpiece and, thereby, a press-on switch 24, which is located in the region of the muzzle 27 of the setting tool 10 produces an actuation signal.

The setting tool 10 can be operated with fuel gas or vaporizable liquid fuel available in a fuel reservoir 20 such as, e.g., fuel can. A fuel conduit 22 connects the fuel reservoir 20 with a fuel inlet 23 of the combustion chamber 15. In the fuel conduit 22, a metering device 21 such as, e.g., metering valve, is located. The metering device 21 controls the fuel supply into the combustion chamber 15.

For supplying electrical consumers such as, e.g., the ignition device 26 and the motor 17 with electrical energy, there is provided an electrical power source 40 such as, e.g., an accumulator.

The control electronics 25 controls both the ignition device 26 and the metering valve 21. The control electronics 25 has, e.g., one or several microprocessors for processing data and for controlling different electrical functions of the setting tool. The control electronics 25 is connected with the power source 40 by an electrical conductor 44.

The control electronics 25 is connected with a first sensor, which is formed as a flue gas sensor 31 (such as, e.g., a lambda probe), and a second sensor formed as a temperature sensor 32. Both the flue gas sensor 31 and the temperature sensor 32 are located in the combustion chamber and transmit, during the operation of the setting tool 10, corresponding measurement data to the control electronics data to the control electronics 25 via corresponding electrical data conductors 41, 42.

The flue gas sensor 31 is in fluid communication with the flue gases produced by combustion of fuel in the combustion chamber 15. Alternatively, the flue gas sensor 31 can be located, e.g., in the exhaust or in the flushing chamber of the setting tool 10.

The measurement with the flue gas sensor takes place after combustion, preferably, before the combustion chamber 15 or the combustion space opens to the environment, and fresh air can enter the combustion chamber.

The measurement function of the flue gas sensor 31 is controlled by the control electronics 25 and is effected, e.g. with a time-delay with regard to actuation of the trigger switch 19 or with regard to ignition pulse produced by the control electronics 25. However, the control electronics 25 can control the flue gas measurement dependent on combustion pressure in the combustion chamber or dependent on the position of the combustion chamber sleeve 28 relative to the housing 11. A timewise control dependent on the metering signal is also possible.

If the flue gas sensor 31 is formed as a lambda probe, then the control electronics 25 can determine a metered amount of fuel, which is to be metered by the metering device 21, for the next setting process dependent on an amount of an unconnected oxygen available in the flue gas. The metering is so selected by the control electronics 25 that lambda ratio equals one (lambda ration is the ratio of air to fuel, at a stoichiometric fuel ratio [lambda]=1, the air amount in the combustion chamber is precisely the amount necessary for a complete combustion of the fuel). Thereby, the entire amount of oxygen, which is contained in the combustion chamber, is completely consumed during a following combustion. As a result, the resulting flue emission of an undesirable flue gas components is very small.

In order to more rapidly reach the optimal operational temperature of the flue gas sensor 31, it is combined with thermal element 33. The thermal element 33 is likewise, controlled by the control electronics 25 and is supplied with electrical energy from the power source 40. An electrical conductor 43 connects the thermal element 33 with the control electronics 25.

For a temperature compensation of the flue gas sensor 31, the temperature sensor 32 is located in the immediate vicinity of the flue gas sensor 31. A suitable software, which is contained in the control electronics 25, or the control routine compensates the deviations of the flue gas sensor 31 at changing measurement temperatures sensed by the temperature sensor 32. The temperature sensor 32 also provides for turning the thermal element 33 off by the control electronics 25 after the operational temperature of the flue gas sensor 31 has been reached. It is to be noted that when the flue gas sensor 31 is formed as a lambda probe, it includes, in addition to a measurement sensor located in the combustion chamber, also a measurement sensor for the environmental air for determining a reference air value.

Alternatively, instead of being formed as a lambda probe, the flue gas sensor 31 can be equipped with means for measuring reaction products of combustion such as carbon monoxide (CO) or carbon oxide (CO₂) so that an optimal air (or oxygen)-fuel ratio and, thereby, a necessary amount of fuel can be determined by the control electronics 25 based on content of such reaction products in the flue gas. The flue gas sensor 31 can also be equipped for measurement of a fuel component such as, e.g., fuel gas isobutan that often forms a fuel component.

For calculation of a metering time necessary for metering a necessary amount of fuel with the control electronics 25, other operational parameters such as fuel level in the fuel reservoir 20, gas pressure in the fuel reservoir 20, temperature of the fuel reservoir 20, voltage of the electrical power source 40, environment temperature, and temperature of the combustion chamber 15 can be taken into account. For measuring these parameters, corresponding sensors are provided on the setting tool 10.

The setting tool, which is shown in FIG. 2, differs from the setting tool 10 shown in FIG. 1, in that the flue gas sensor 31 and the thermal element 33 are mounted not in or on the combustion chamber 15 but rather in or on an exhaust 35 of the setting tool 10. The temperature sensor 32 can remain, as shown, in the combustion chamber 15 or, alternatively, also be located in the exhaust 35. Otherwise, the explanations given with respect to FIG. 1 are valid for the setting tool 10 shown in FIG. 2; therefore, with regard to the reference numerals not specifically mentioned above, a corresponding description made with reference to FIG. 1 applies in its entirety.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A combustion-operated setting tool (10) for driving-in fastening elements, comprising:
a combustion chamber (15) for fuel;
an ignition device (26) for generating an ignition spark in the combustion chamber (15);
a metering device (21) for delivering fuel in the combustion chamber (15);
control electronics (25) for controlling the ignition device (26) and the metering device (21);
a plurality of sensors for sensing operational parameters of the setting tool, connected with the control electronics (25), and including at least one flue gas sensor (31) for measuring at least one flue gas component.

2. A combustion-operated setting tool according to claim 1, wherein the flue gas sensor (31) is equipped for measuring at least one primary component of the flue gas.

3. A combustion-operated setting tool according to claim 1, wherein the flue gas sensor (31) is formed as lambda probe for measuring content of residual oxygen in the flue gas.

4. A combustion-operated setting tool according to claim 1, wherein the flue gas sensor (31) is equipped for measuring a reaction product in the flue gas.

5. A combustion-operated setting tool according to claim 1, wherein the flue gas sensor (31) is formed as a carbon monoxide sensor.

6. A combustion-operated setting tool according to claim 1, wherein the flue gas sensor (31) is formed as a carbon oxide sensor.

7. A combustion-operated setting tool according to claim 1, wherein the flue gas sensor (31) is located in the combustion chamber (15).

8. A combustion-operated setting tool according to claim 1, wherein the flue gas sensor (31) is located in exhaust (35).

9. A combustion-operated setting tool according to claim 1, further comprising a thermal element (33) for the flue gas sensor (31).

10. A combustion-operated setting tool according to claim 9, wherein the thermal element (33) is controlled by the control electronics (25).

11. A combustion-operated setting tool according claim 1, wherein the plurality of sensors includes a temperature sensor located in the combustion chamber (15).
